(19) United States
(12) Patent Application Publication
(10) Pub. No.: US 2016/0298968 A1
(43) Pub. Date: Oct. 13, 2016

(54) Mall Tracker

(71) Applicants: Matthew Esch, Katy, TX (US); Luke W. Lozoya, Beaumont, TX (US)

(72) Inventors: Matthew Esch, Katy, TX (US); Luke W. Lozoya, Beaumont, TX (US)

(21) Appl. No.: 14/682,105

(22) Filed: Apr. 9, 2015

(51) Int. Cl. G01C 21/20; G06Q 30/06

(52) U.S. Cl. CPC G01C 21/206; G06Q 30/0639

(57) ABSTRACT

Disclosed herein is a system to create a travel itinerary to facilitate navigation that is comprised of a server, which is respectively comprised of a database for storing interactive maps of locations, and a computer program product for performing a method to create a travel itinerary and facilitate navigation in indoor and outdoor locations on an electronic device. The method is further comprised of a means for specifying a criterion for a query, means for querying said interactive map with said criterion to obtain information defining said travel itinerary, receiving a signal from said electronic device, sending at least one set of interactive maps to said electronic device, displaying said travel itinerary as at least one map, routing instructions, displaying consumer information, loading local map of the area/facility to said electronic device, displaying the position on the display device overlay on said facility/area map, and navigate between tags position on the area/facility maps.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

(1) Field of the Invention

The present invention relates to a system and method of creating a travel itinerary to facilitate navigation in an indoor and outdoor location and displaying on a portable computing device the travel itinerary and navigation on an interactive map.

(2) Background of Invention

Personal navigation methods have evolved over recent years. Previously, if a person was trying to find a location in an area in they did not know, they could use a map, if there was one available, or they could ask someone for directions. When giving directions, people often refer to obvious landmarks to help to describe the route and to help the person finding their way to recognize if they are on the right track. Location based services are rapidly expanding. Outdoor location technologies are mainly based on GPS technologies. GPS cannot perform properly indoors, and is, therefore, inadequate. As a result, indoor location systems are appearing on the market. The need for a system such as ours arises from various market segments and applications. One example in the market is the GPS based systems that use integrated positioning and navigation systems that are based on GPS receivers as the primary positioning technology. Subsequent to the events of September 11th, the Federal government mandated that GPS capability be built into all cellular phones. However, the fact that uninterrupted satellite reception is not possible in many locations is a major limitation of GPS based systems. Densely populated areas and radio-frequency-signal shadowed locations, such as urban centers (a.k.a. “urban canyons”), generally do not allow proper operation of GPS, yet it is in these locations that the need is greatest.

Furthermore, various kinds of systems and applications are available that provide people with useful information while traveling. For example, navigation systems that are installed in vehicles provide useful information to vehicle drivers and passengers, including information for finding desired destinations, as well as guidance for following routes to desired destinations. Similar features are available on portable (e.g., handheld) devices. These types of portable devices include personal navigation systems (PNSs), which are portable devices designed specifically to provide navigation and/or map-related features, such as destination searches, routing, and/or map display. These types of portable devices also include general purpose devices, such as personal digital assistants (PDAs), on which are installed navigation and/or map-related applications. These types of portable devices can be used in vehicles, but can also be carried by pedestrians or by people using other modes of transportation, such as trains, boats, and so on.

A continuing consideration associated with providing navigation and/or map information on portable devices is making the information easy to understand given the relatively small size of the display. Portable devices, such as personal navigation systems and personal digital assistants, have relatively small display screens compared to desktop computers, notebook computers, or even in-vehicle navigation systems. Therefore, efficient utilization of available display screen resources can be a factor when providing navigation and/or map related features on a portable device.

There is a clear need for a cost effective system that maintains performance in both indoor and outdoor locations.

### BRIEF SUMMARY OF THE INVENTION

The primary objective of the invention is to provide a system to create a travel itinerary to facilitate navigation in indoor and outdoor locations. The system is comprised of a server, wherein the server is further comprised of a database for storing interactive maps of locations, and a computer program product for performing a method to create a travel itinerary and facilitate navigation in indoor and outdoor locations. This is then displayed on an electronic device that has a display and has telecommunication capabilities (like mobile phones, PDA's etc.) as an interactive map.

According to the invention, the method to create a travel itinerary and facilitate navigation includes a means for specifying a criterion for a query. The criterion includes at least one start point and an end point of the travel itinerary. However, the start point and the end point are geographic locations, and at least one route point must be provided. The route point could be a service, product, place, activity, or event. In one embodiment, the method provides a means for querying the interactive map with the criterion to obtain information defining the travel itinerary. Further, the information includes mapping information with geographic information related to the start point, end point, and the route point. The route point, however, has descriptive information, such as consumer information related to at least one route point. In a preferred embodiment, the method in the invention receives a signal from the electronic device that specifies at least one end point and a request for at least one route leading to at least one end point. Furthermore, the invention then sends at least one set of interactive maps to the electronic device, wherein each map of the set of maps defines a unique route leading to one end point.

The method also displays said travel itinerary as a map. The map includes routing instructions, the consumer information, and a local map of the area/facility. The map, however, can be pre download before arriving at the area. Furthermore, the method displays the position on the display device overlaid on the facility/area map and navigates between tags position on the area/facility maps.

In yet another embodiment of the present invention, the method displays additional information that pertains to the area, such as bathrooms, rest areas, vendors inside of the mall, stores, food courts, movie theaters, entertainment areas, and other places or events that would take place in the location. The additional information may also indicate store hours, coupons provided by stores, and special deals offered by vendors.

Furthermore, the invention generates routes for available empty parking spaces, which become the start point, and are closest to the end point. The device then provides a route to the end point from the parking spaces. Also, the invention allows generating said travel itinerary indicating a plurality of route points over said map, and the route point, start point, and/or end point is graphically represented as a pin on said map.

The summary is provided to introduce a selection of concepts, in a simplified form, that are further described below in the detailed description. This summary is not intended to identify key features or essential features of the subject matter, nor is it intended to be used as an aid in determining the scope of the subject matter. In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting. These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### DETAILED DESCRIPTION OF THE INVENTION

The example embodiments are in such detail as to clearly communicate the invention. However, the amount of detail offered is not intended to limit the anticipated variations of embodiments. On the contrary, the intention is to cover all modifications, equivalents, and alternatives falling within the spirit and scope of the present invention. The detailed descriptions below are designed to make such embodiments obvious to a person of ordinary skill in the art.

The present invention can be implemented on any communication device that has hardware components that can perform wireless and wired communication, such as (but not limited to)—multi-purpose pocket computers, personal multimedia devices, etc.

The various devices on which the applications that implement the present invention run may use one or more processors with different instruction-sets, architectures, clock-speeds, etc. and memory, which may include high speed random access memory, and may include non-volatile memory, such as one or more magnetic disk storage devices, flash memory devices, and other kinds of solid state memory devices.

The various applications that can implement the present invention run on electronic devices that may use at least one physical user interface device that provide the means of control and navigation within the operating system. Applications that run on the devices include (but not limited to) touch-pads, such as those described in (but not limited to)—(1) U.S. patent application Ser. No. 10/722,948 (“Touch pad for handheld device”, filed Nov. 25, 2003); (2) U.S. patent application Ser. No. 10/188,182 (“Touch pad for handheld device”, filed Mar. 21, 2006); (3) U.S. patent application Ser. No. 08/210,610 (“Computer system with touchpad support in operating system”, filed Mar. 18, 1994); (4) U.S. Pat. No. 643,256 (“Movable touch pad with added functionality”, filed Ser. No. 10/643,256), touch screens such as those described in (but not limited to) (1) U.S. patent application Ser. No. 11/381,313, “Multipoint Touch Surface Controller,” filed on May 2, 2006; (2) U.S. patent application Ser. No. 10/840,862, “Multipoint Touchscreen,” filed on May 6, 2004; (3) U.S. patent application Ser. No. 10/903,964, “Gestures For Touch Sensitive Input Devices,” filed on Jul. 30, 2004; (4) U.S. patent application Ser. No. 11/048,264, “Gestures For Touch Sensitive Input Devices,” filed on Jan. 31, 2005; (5) U.S. patent application Ser. No. 11/038,590, “Mode-Based Graphical User Interfaces For Touch Sensitive Input Devices,” filed on Jan. 18, 2005; (6) U.S. patent application Ser. No. 11/228,758, “Virtual Input Device Placement On A Touch Screen User Interface,” filed on Sep. 16, 2005; (7) U.S. patent application Ser. No. 11/228,700, “Operation Of A Computer With A Touch Screen Interface,” filed on Sep. 16, 2005; (8) U.S. patent application Ser. No. 11/228,737, “Activating Virtual Keys Of A Touch-Screen Virtual Keyboard,” filed on Sep. 16, 2005 and (9) U.S. patent application Ser. No. 11/367,749, “Multi-Functional Hand-Held Device,” filed on Mar. 3, 2006, click wheel such as those described in U.S. patent application Ser. No. 11/549,619 “Method, device, and graphical user interface for dialing with a click wheel” filed on Oct. 13, 2006, keyboards, such as those mentioned in (but not limited to) U.S. patent application Ser. No. 07/711,760 (“Ergonomic keyboard input device”, filed on Jun. 6, 1991), mouse, such as those described in (but not limited to) (1) application Ser. No. 09/167,314 (“Computer mouse with enhance control button (s)”, filed on Oct. 6, 1998); (2) application Ser. No. 08/288,945 (“Roller mouse for implementing scrolling in windows applications”, filed on Aug. 10, 1994) and gesture recognition means, such as those described in (but not limited to) (1) European Patent application publication number: EP2482176 A2 (“Multi-input gesture control for a display screen”, filed on Nov. 4, 2011) and (2) U.S. Patent application with publication number 20120317511 A1 (“DISPLAY WITH BUILT IN 3D SENSING CAPABILITY AND GESTURE CONTROL OF TV”, filed on Aug. 21, 2012).

Display means used by these devices may use LCD (liquid crystal display) technology, LED (light Emitting Diode) technology, CRT (Cathode ray tube) technology, LPD (light emitting polymer) technology, or any other display technologies. Various realizations of graphics display circuitry that implement a Graphics Processing Unit (GPU) are used to achieve video interface between user and these electronic devices.

Connectivity of these devices with networks, such as the internet, an intranet and/or wireless network, such as a cellular telephone network, a wired or wireless local area network (LAN) and/or metropolitan area network (MAN) and/or WAN (wide area network), and other wireless communication, is achieved by use of a plurality of communication standards, protocols, and technologies, such as Bluetooth, Wireless Fidelity (Wi-Fi), and/or any other suitable communication protocol, including communication protocols not yet developed as of the filing date of this document.

The present invention may be implemented on applications that run on a single or variety of operating system platforms, including but not limited to OS X, WINDOWS, UNIX, IOS, ANDROID, SYMBIAN, LINUX, or embedded operating systems, such as VxWorks.

The present invention may also be implemented to work with various web browsers, including but not limited to Internet Explorer, Mozilla Firefox, Safari, and Opera, that access and handle various types of web pages constructed with various mark-up languages, such as HTML, HTML-5, XHTML, XML, etc. and the associated CSS (cascading style sheet) files and java-script files.

According to the system disclosed, a user will be able to locate a mall and route himself or herself to the entity of their choosing. The system creates a travel itinerary to facilitate navigation in indoor and outdoor locations. The system is comprised of a server, wherein the server is further comprised of a database for storing interactive maps of locations, and a computer program product for performing a method to create a travel itinerary and facilitate navigation in indoor and outdoor locations. This is then displayed on an electronic device that has a display and has telecommunication capabilities (like mobile phones, PDA's etc.) as an interactive map.

According to the invention, the method to create a travel itinerary and facilitate navigation includes a means for specifying a criterion for a query. The criterion includes at least one start point and an end point of the travel itinerary. However, the start point and the end point are geographic locations, and at least one route point must be provided. The route point could be a service, product, place, activity, or event. In one embodiment, the method provides a means for querying the interactive map with the criterion to obtain information defining the travel itinerary. Further, the information includes mapping information with geographic information related to the start point, end point, and the route point. The route point, however, has descriptive information, such as consumer information related to at least one route point. In a preferred embodiment, the method in the invention receives a signal from the electronic device that specifies at least one end point and a request for at least one route leading to at least one end point. Furthermore, the invention then sends at least one set of interactive maps to the electronic device, wherein each map of the set of maps defines a unique route leading to one end point.

The method also displays said travel itinerary as a map. The map includes routing instructions, the consumer information, and a local map of the area/facility. The map, however, can be pre download before arriving at the area. Furthermore, the method displays the position on the display device overlaid on the facility/area map and navigates between tags position on the area/facility maps.

In yet another embodiment of the present invention, the method displays additional information that pertains to the area, such as bathrooms, rest areas, vendors inside of the mall, stores, food courts, movie theaters, entertainment areas, and other places or events that would take place in the location. The additional information may also indicate store hours, coupons provided by stores, and special deals offered by vendors.

Furthermore, the invention generates routes for available empty parking spaces, which become the start point, and are closest to the end point. The device then provides a route to the end point from the parking spaces. Also, the invention allows generating said travel itinerary indicating a plurality of route points over said map, and the route point, start point, and/or end point is graphically represented as a pin on said map. The system enables a user to make a “Mall Plan,” meaning a user will be able to choose multiple amounts of stores he/she want to go to and the system will generate a routing plan for the user. To add to this, a user can incorporate a location using the pin drop feature. Also, users can drop a pin where they are parked. Once a user is ready to leave the mall, they can click the pen and it will route them straight to their vehicle. Furthermore, a user will be able to instantly choose which side of the mall to park on depending on the stores they are going to shop at. If a consumer wants to shop at a specific store and doesn't know where the store is inside the mall, the user can select that store and the system will tell the user where to park for the quickest entry to that store.

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

We claim:

1. An electronic server system comprises:
storing means for interactive maps of locations;
programming means for creating a travel itinerary, facilitating indoor and outdoor location navigation in an electronic device with displaying of an interactive map;
specifying means for a criterion for a query;
querying means for said interactive map with said criterion to obtain information defining said travel itinerary;
receiving means for a signal from said electronic device,
sending means for at least one set of said interactive map to said electronic device;
displaying means for said travel itinerary as at least one said interactive map, routing instructions, and the consumer information;
loading means for local maps of the area/facility to said electronic device prior arriving to the area;
displaying means the position on of said device overlay on the facility/area map; and
navigating means for position tags on the area/facility maps.

2. The electronic server system of claim 1 wherein said criterion including at least one start point and at least one end point as geographic locations of said travel itinerary for useful consumer information.

3. The electronic server system of claim 1 wherein said interactive map displaying geographic Information related to at least one said start point and at least one said end point and at least said one route point including consumer information related to said at least one route point.

4. The electronic server system of claim 1 wherein said receiving means specifying at least said one start point and said end point and requesting for at least said one route leading to said at least one end point.

5. The electronic server system of claim 1 wherein said at least one set of maps defines a unique consumer route leading to said at least one end point.

6. The electronic server system of claim 1 wherein said criterion including at least one route point of a service, a product, a place, an activity, and an event.

7. The electronic server system of claim 1 wherein said displaying means providing useful consumer information pertaining to said location on said interactive map.

8. The electronic server system of claim 1 wherein said information including useful consumer information about local area indicating at least one route point.

9. The electronic server system of claim 1 wherein said information including useful consumer information about local area indicating points as bathrooms, rest areas, vendors inside the mall, stores, food courts, movie theater, entertainment areas and other places or events that would take place in said location.

10. The electronic server system of claim 1 wherein said information including useful consumer information about local area indicating information indicating store hours, coupons provided by stores, special deals offered by vendors of a shopping mall.

11. The electronic server system of claim 1 wherein said information including useful consumer information about local area indicating generating route for an available empty parking space which is closest to said end point and said route The method according to claim 6, wherein said empty parking spaces is said start point.

12. The electronic server system of claim 1 wherein said interactive map generating said travel itinerary indicating a plurality of route points over said map.

13. The electronic server system of claim 1 wherein said start point route point and/or end point is marked as a pin on said map.
